(19) United States
(12) Patent Application Publication
(10) Pub. No.: US 2021/0295235 A1
(43) Pub. Date: Sep. 23, 2021

(54) EVALUATION SYSTEM, EVALUATION METHOD, AND NON-TRANSITORY COMPUTER READABLE STORAGE MEDIUM

(71) Applicant: Yokogawa Electric Corporation, Tokyo (JP)

(72) Inventor: Masayasu OHASHI, Tokyo (JP)

(21) Appl. No.: 17/159,375

(22) Filed: Jan. 27, 2021

(30) Foreign Application Priority Data
Mar. 17, 2020 (JP) 2020-046356

(51) Int. Cl. G06Q 10/06; G06Q 50/04; G06F 16/248

(52) U.S. Cl. CPC G06Q 10/06395; G06F 16/248; G06Q 50/04

(57) ABSTRACT

An evaluation system includes an indicator value collector configured to collect evaluation indicator values which are values of evaluation indicators predetermined in association with production factors of products for each lot of the products, and an evaluator configured to derive a distribution of the evaluation indicator values for a plurality of lots and to generate public values which are values for making the evaluation indicators public for each of the lots based on a deviation of the evaluation indicator values in the distribution.

### BACKGROUND

### Technical Fields

The present invention relates to an evaluation system, an evaluation method, and a non-transitory computer readable storage medium.

Priority is claimed on Japanese Patent Application No. 2020-046356, filed on Mar. 17, 2020, the contents of which are incorporated herein by reference.

### Description of Related art

Conventionally, in production facilities such as plants or factories, a production system such as a process control system is constructed and advanced automatic operations are realized. In such a production system according to the related art, conditions for production factors (factors for producing a product) are set on the basis of scientific techniques or production techniques which have been established in laboratories. Product quality has been secured by maintaining the set conditions. Here, materials (Material), facilities (Machine), processes (Method), and persons (Man) are often referred to as the “four factors of production.” The “four factors of production” are also referred to as “4M.”

A technology for identifying obstructive factors that cause non-uniformity in product performance and stabilizing product performance and manufacturing performance is disclosed in Japanese Unexamined Patent Application Publication No. 2016-177794. In the technology disclosed in Japanese Unexamined Patent Application Publication No. 2016-177794, lots in manufacturing processes are classified into a plurality of groups depending on main component scores which are generated on the basis of process data, and superiority and inferiority of the plurality of groups are determined on the basis of product data. By identifying obstructive factors contributing to superiority and inferiority of the groups, product performance and manufacturing performance are stabilized.

Recently, requirements for product quality from consumers of products to producers have been stricter. For example, for already established products, there are requirements for keeping product prices down while maintaining the same quality as in the past and the like. On the other hand, non-uniformity in production factors at the time of production has become significant. In the production systems according to the related art, non-uniformity in product quality is curbed by imposing a burden on “Method” (substantially control such as process control) out of the “four factors of production.” However, non-uniformity in the production factors tends to increase and an influence on product quality may not be curbed according to only “Method.”

In general, delivery specifications of a product are exchanged for a sales contract between a consumer and a producer of the product. Many specifications defined in the delivery specifications are numerical values (capacity, mass, viscosity, transparency, component ratios, and the like) which can be actually measured in products (if necessary, by the consumer of the product). In the following description, numerical values (evaluation values) which can be measured in products are referred to as “output evaluation values.” On the other hand, the expectations for products of the consumer are often not limited to product specifications (output evaluation values). An example of such expectations is deterioration with age (for example, deterioration with age in viscosity or transparency after five years) of the products. This can be checked to a certain extent through an acceleration test such as a thermal shock test by sampling, but such expectations cannot be coped with through an acceleration test by sampling (an acceleration test on all products is actually necessary and stress due to the acceleration test is applied to the products) when expectations for products are very high (for example, a product transparency of 99.9% being maintained over five years). For a consumer of a product, a method of not changing a producer of a product may be employed as a means with respect to the expectations for (securing) quality other than with respect to output evaluation values of the product. This is based on the expectation that the same producer will continue to produce products with the same quality. However, the consumer of a product may not be able to understand change of production factors of the product from the output evaluation values of the product. Therefore, a consumer of a product may require a producer of the product to maintain the production factors of the product and further to present evaluation results thereof. In the following description, an evaluation value such as change of a production factor which cannot be expressed by output evaluation values of a product is referred to as a “process evaluation value.” On the other hand, with respect to a producer of a product, when process evaluation values of the product are presented to a consumer of the product without any change, there is a likelihood that another producer (a rival company) will imitate production processes on the basis of the presented process evaluation values (leakage of production know-how). In addition, by disclosing (promising) stringent production processes to a consumer, room for improvement for a decrease in production costs of the producer may be reduced.

### SUMMARY

An evaluation system may include: an indicator value collector configured to collect evaluation indicator values which are values of evaluation indicators predetermined in association with production factors of products for each lot of the products; and an evaluator configured to derive a distribution of the evaluation indicator values for a plurality of lots and to generate public values which are values for making the evaluation indicators public for each of the lots based on a deviation of the evaluation indicator values in the distribution.

Further features and aspects of the present disclosure will become apparent from the following detailed description of exemplary embodiments with reference to the attached drawings.

### BRIEF DESCRIPTION OF THE DRAWINGS

FIG. 1 is a diagram illustrating an example of a configuration of a production system according to a first embodiment;

FIG. 2 is a diagram illustrating an example of a method evaluation indicator definition according to the first embodiment;

FIG. 3 is a diagram illustrating an example of a configuration of an evaluation system according to the first embodiment;

FIG. 4 is a diagram illustrating an example of a public value which is correlated with a reaction time for each lot according to the first embodiment;

FIG. 5 is a diagram illustrating an example of public values according to the first embodiment;

FIG. 6 is a flowchart illustrating an example of operations which are performed in the evaluation system according to the first embodiment;

FIG. 7 is a diagram illustrating an example of a configuration of a production system according to a second embodiment;

FIG. 8 is a diagram illustrating an example of a configuration of an evaluation system according to the second embodiment;

FIG. 9 is a diagram illustrating an example of evaluation indicator definitions according to the second embodiment;

FIG. 10 is a diagram illustrating an example of grouped public values according to the second embodiment;

FIG. 11 is a diagram illustrating an example of layered public values according to the second embodiment;

FIG. 12 is a diagram illustrating an example of a configuration of a production system according to a third embodiment;

FIG. 13 is a diagram illustrating an example of a quality evaluation indicator definition according to the third embodiment;

FIG. 14 is a diagram illustrating an example of a configuration of an evaluation system according to the third embodiment;

FIG. 15 is a diagram illustrating an example of a quality value which is correlated with transparency for each lot according to the third embodiment;

FIG. 16 is a diagram illustrating an example of a quality value according to the third embodiment;

FIG. 17 is a diagram illustrating an example of a tree diagram of groups of layered public values according to the third embodiment; and

FIG. 18 is a diagram illustrating an example of a scatter diagram of the groups of the layered public values and the quality values according to the third embodiment.

### DETAILED DESCRIPTION OF THE EMBODIMENTS

The embodiments of the present invention will be now described herein with reference to illustrative preferred embodiments. Those skilled in the art will recognize that many alternative preferred embodiments can be accomplished using the teaching of the present invention and that the present invention is not limited to the preferred embodiments illustrated herein for explanatory purposes.

An aspect of the present invention is to provide an evaluation system, an evaluation method, and a non-transitory computer readable storage medium that can secure reliability of products for consumers (reliability indicating that there is no change in product quality from that in the past) and prevent leakage of production know-how of the products or the like to a third party.

Hereinafter, an evaluation system, an evaluation method, and a non-transitory computer readable storage medium according to embodiments of the invention will be described in detail with reference to the accompanying drawings. In the following description, the outline of the embodiments of the invention will be first described and details of the embodiments of the invention will be then described.

### [Outline]

Even when evaluation results (process evaluation values) of non-uniformity in production factors of a product is presented to a consumer by a producer, the embodiments of the invention can prevent another producer from imitating production processes on the basis of the evaluation results.

In the equipment industries, technology has matured and stable operations have been performed in the long history thereof. In production methods according to the related art, predetermined production conditions have been set for each production factor on the basis of scientific techniques or production techniques which have been established in laboratories and producers have maintained the quality of products by maintaining the production conditions.

Producers often produce products as materials for finished products. For example, a producer may produce a film (a resin) as a material for a smartphone which is a finished product. For the purpose of placing priority on the quality of products, such a producer purchases materials from the same predetermined material manufacturer, carries out the same predetermined production processes, performs the same predetermined quality check on the products, and provides products to a consumer who is a customer of the producer in a supply chain of the manufacturing industry.

A consumer who is a customer of a producer orders a necessary amount of products from a producer. In order to produce the products, the producer orders a necessary amount of materials from a material manufacturer and receives the materials before a deadline for delivery. The producer produces products using the received materials and delivers the products to the consumer up to a deadline for delivery. In a supply chain according to the related art, the same producer is often selected as an ordering destination on the basis of transactions over the long term or quality results in the past.

In this way, a producer is selected on the basis of past custom, and a consumer orders products from a plurality of producers which are selected on the basis of past custom, whereby delivery delays or poor quality of products is prevented from adversely affecting the consumer.

Production conditions for keeping the quality of products at a predetermined level are determined for each production factor. For example, the production conditions are determined for each production factor of “4M” as follows.
Production factor “Material”: In general, a material includes a plurality of components. Allowable ranges for the plurality of components are determined according to the production conditions.
Production factor “Machine”: A plant user or a plant engineer designs facilities at the time of construction or repair of the facilities. The facilities are constructed or mounted on the basis of this design.
Production factor “Method”: In the related art, conditions of the materials and the facilities are kept constant and non-uniformity in each production factor is absorbed by “Method.” In the related art, real-time control using sequence control logic, proportional integral differential (PID) control logic, or the like is performed in the production processes such that target results are achieved.
Production factor “Man”: A person processes a part which is less likely to be automated in production facilities. Examples of the processing of a part which is less likely to be automated include treatment for coping with an abnormality which has occurred, replacement of a production object, and repair of production facilities.

A technique of producing a product from a material using “4M” and the whole system thereof may be referred to as a “production management system.” A whole system that provides techniques and functions in which 3M other than “Method” out of “4M” is not changed or a whole system that provides techniques and functions of curbing change of the “Method” may be referred to as a “process control system.”

Examples in the current environment constraining current production industries include intensification in global competition, large fluctuations in the cost of energy and materials, reduction in numbers and aging of the working population, and diversification of supply chains independently of affiliates. Due to such changes in the environment, the following phenomena (1) to (4) have started to occur in production management systems of producers.

(1) The quality of materials (Material) is not necessarily uniform.

(2) The deterioration of facilities (Machine) over time is in progress.

(3) In the processes (Method), producers are confronted with problems which have not been manifested until now.

(4) The number of veterans (Man) is decreasing and producers are losing operating know-how for their facilities.

That is, producers have to provide products for consumers with a higher quality and more differentiation than ever before in spite of the non-uniformity in the quality of materials, facilities undergoing deterioration with age, and a smaller number of personnel with less operation know-how for facilities.

In addition, producers who are downstream in a supply chain must be committed to providing products with a stringent uniform high quality required by consumers. For example, a producer may be required by a consumer to disclose production processes in order to prove that the quality of products is the same as that in the past (that the quality in the past has been maintained). For example, a consumer may instruct a producer to use materials such that the producer does not use cheap materials.

In this way, stringent ordering conditions are being presented to producers by consumers. In order to conform to the requirements of a consumer, all-point inspection of products has to be properly performed before shipment of the products. However, when there is an inspection item requiring breakage of a product, all-point inspection of products cannot be performed, production costs increase, and it takes time to ship the products. Accordingly, there is a limit on a workload which is able to be imposed for inspection of products before shipment. However, when quality defects occur even once, there is a risk of a consumer not ordering from a certain producer again next time.

Therefore, a producer needs to visualize the quality of products. Numerical values for visualizing the quality of products include numerical values (output evaluation values) associated with the quality of products which are provided to consumers and numerical values (process evaluation values) associated with production processes of products which are provided to consumers. The output evaluation values are evaluation values which can be measured for products such as measured values and deviations in the products which are supplied to consumers. The process evaluation values are numerical values which are measured or managed in the production processes. By disclosing the process evaluation values to consumers, the process evaluation values serve as a certificate for allowing the consumers to use the products with confidence. However, as few as possible process evaluation values (values measured in the production processes without any change) are directly presented to consumers in the related art in view of prevention of leakage of know-how or the like.

In the embodiments of the invention, an evaluation system collects evaluation indicator values which are values of evaluation indicators which are predetermined for production factors of products (Key Performance Indicator) for each lot of produced products (hereinafter referred to as “each product lot”). The evaluation indicator values are also referred to as process evaluation values without any change. The evaluation system derives a distribution of the evaluation indicator values for each of a plurality of product lots. The evaluation system generates values for making the evaluation indicators public for each product lot on the basis of a deviation of the evaluation indicator values with respect to the center of the distribution of the evaluation indicator values. Accordingly, in the embodiments of the invention, even when the values for making the evaluation indicators public are presented from a producer to a consumer as results of process evaluation of production factors of products, it is possible to prevent another producer (a rival company) from imitating the production processes on the basis of the results of process evaluation.

### First Embodiment

### <Production System>

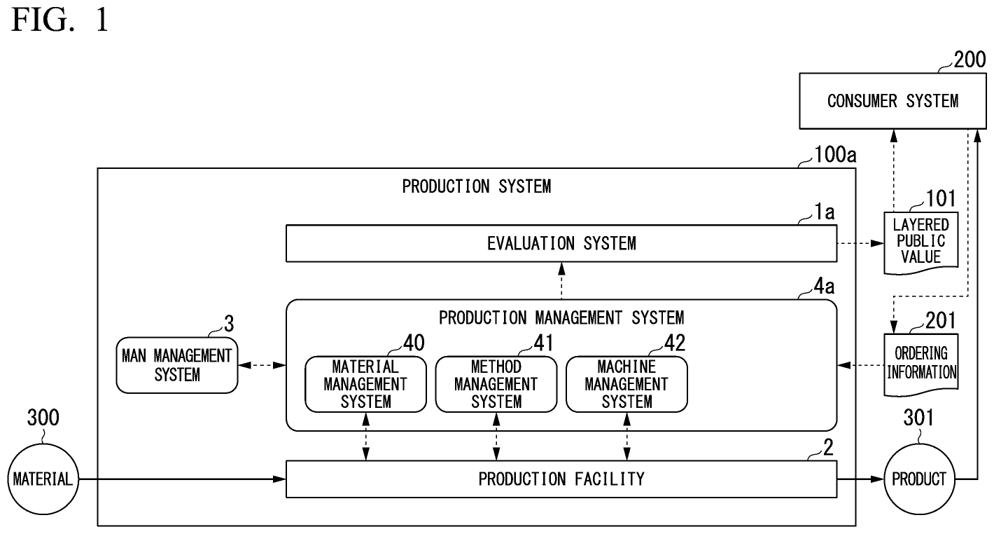

FIG. 1 is a diagram illustrating an example of a configuration of a production system 100a according to a first embodiment. The production system 100a is a system that procures products using materials. The production system 100a is managed by a producer (for example, a material manufacturer). The production system 100a produces a product 301 using a material 300 on the basis of ordering information 201 which is acquired from a consumer system 200. The production system 100a outputs values for disclosing evaluation indicators (hereinafter referred to as “public values”) 101 and the product 301 to the consumer system 200.

The public value 101 serves as a certificate indicating that the product is a product which is produced through the same production processes as normal (as usual). Since the public value 101 is not an evaluation indicator value (for example, the temperature of a reactor which is provided in a production facility) itself, another producer cannot imitate the production processes on the basis of the public value 101. An evaluation indicator value is predetermined for each production factor of the product 301. The production factors include, for example, material, machine, method, and man. A plurality of evaluation indicator values are generally provided for each production factor (for example, a production area, a grade, and viscosity of a material). In the first embodiment, an example in which one evaluation indicator value which is considered to most affect product quality is set for each production element is described (an example in which a plurality of evaluation indicator values are set for each production factor will be described later). For example, when a producer is a material manufacturer, the product 301 is a material which is produced in the production system 100a.

### <Consumer System>

The consumer system 200 is a system that is managed by a consumer (repeater) of the product. The consumer system 200 transmits ordering information 201 of the product 301 to the production system 100a. For example, when a consumer is a finished product manufacturer, the product 301 is a material for a finished product which is produced in the consumer system 200. The consumer system 200 acquires the public value 101 and the product 301 from the production system 100a.

The configuration of the production system 100a will be described below.

The production system 100a includes an evaluation system la, a production facility 2, a man management system 3, and a production management system 4a. The production management system 4a includes a material management system 40, a method management system 41, and a machine management system 42.

The production facility 2 includes facilities which are required for production of a product. The required facilities include, for example, pipes, valves, pumps, reactors, and tanks. The production facility 2 produces (manufactures) the product 301 using the material 300 under the control of the production management system 4a. The man management system 3 outputs a value of an evaluation indicator which is predetermined in association with persons (a personnel employed in production of products) (hereinafter referred to as a “man evaluation indicator value”) to the evaluation system 1a via the production management system 4a.

The production management system 4a controls the operation of the production facility 2 on the basis of the ordering information 201. The material management system 40 generates a value of an evaluation indicator which is predetermined in association with materials (hereinafter referred to as a “material evaluation indicator value”). The method management system 41 generates a value of an evaluation indicator which is predetermined in association with production processes (hereinafter referred to as a “method evaluation indicator value”). The machine management system 42 generates a value of an evaluation indicator which is predetermined for facilities (hereinafter, referred to as a “machine evaluation indicator value”). The production management system 4a may generate a value of an evaluation indicator which is predetermined in association with environments of the production facilities (hereinafter referred to as an “environment evaluation indicator value”).

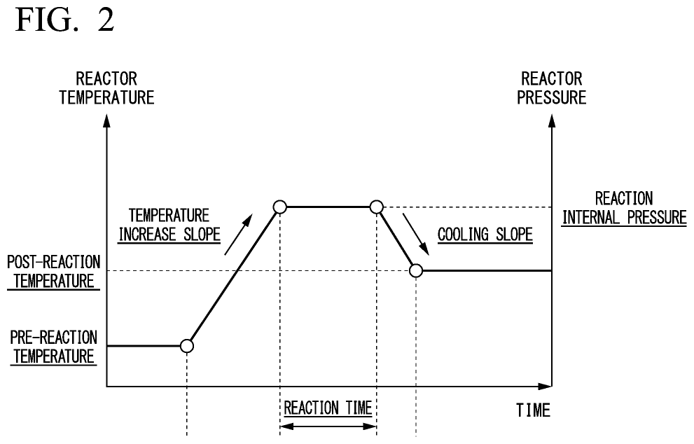

FIG. 2 is a diagram illustrating an example of the method evaluation indicator value according to the first embodiment. The method evaluation indicator value is a process evaluation value which is considered to most affect the product quality and is, for example, one of a pre-reaction temperature, a temperature increase slope, a reaction time, a reaction internal pressure, a cooling slope, and a post-reaction temperature in a reactor (not illustrated) of the production facility 2.

The evaluation system 1a illustrated in FIG. 1 collects the evaluation indicator values of the production factors from the production management system 4a for each lot of the product 301. The evaluation system 1a generates the public value 101 for each lot of the product 301 as a certificate for verifying that the product is a product which has been produced in the normal (usual) production processes. The evaluation system 1a transmits the public value 101 to the consumer system 200 for each lot of the product 301.

An example of the configuration of the evaluation system 1a will be described below.

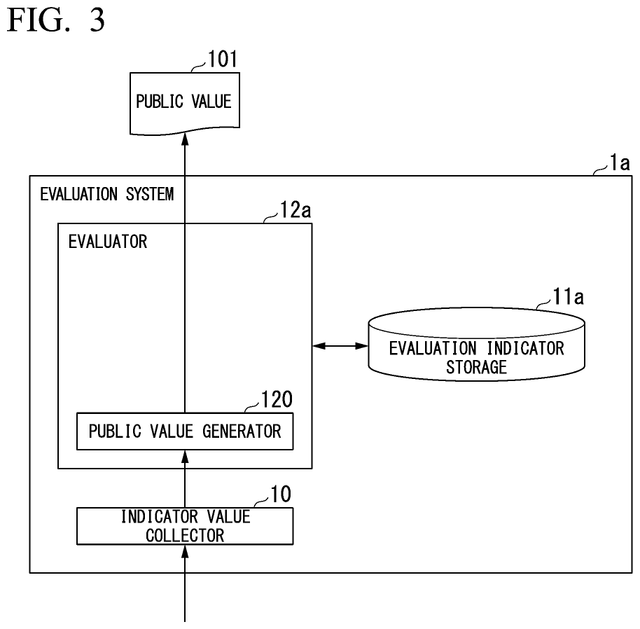

FIG. 3 is a diagram illustrating an example of the configuration of the evaluation system 1a according to the first embodiment. The evaluation system 1a includes an indicator value collector 10, an evaluation indicator storage 11a, and an evaluator 12a. The evaluator 12a includes a public value generator 120.

The indicator value collector 10 collects a material evaluation indicator value, a machine evaluation indicator value, a method evaluation indicator value, a man evaluation indicator value, and an environment evaluation indicator value from the production management system 4a for each product lot. The indicator value collector 10 acquires a product lot number of the product 301 from the production management system 4a for each product lot. The indicator value collector 10 transmits the material evaluation indicator value, the machine evaluation indicator value, the method evaluation indicator value, the man evaluation indicator value, the environment evaluation indicator value, and the product lot number of the product 301 to the evaluator 12a. The evaluation indicator storage 11a stores the evaluation indicator values. The evaluation indicator storage 11a outputs the evaluation indicator values to the public value generator 120.

The public value generator 120 acquires the evaluation indicator values in the past product lots from the evaluation indicator storage 11a. The public value generator 120 acquires the material evaluation indicator value, the machine evaluation indicator value, the method evaluation indicator value, the man evaluation indicator value, the environment evaluation indicator value, and the product lot number of the product 301 in the lot under production from the indicator value collector 10. The public value generator 120 compares the evaluation indicator values in the lot under production with the evaluation indicator values in the past product lots, and derives a distribution thereof. The public value generator 120 generates public values for each lot on the basis of a deviation in the distribution of the evaluation indicator values. That is, a public value is a numerical value indicating where in the distribution of the evaluation indicator values in the past product lots the evaluation indicator values which are the process evaluation values in the lot under production are located. Accordingly, a consumer has a difficulty in deriving the evaluation indicator values (the process evaluation values) without any change from the public values and thus it is possible to prevent leakage of production know-how or the like. The public values are expressed, for example, by an integer (a score) in a range of 1 to 5.

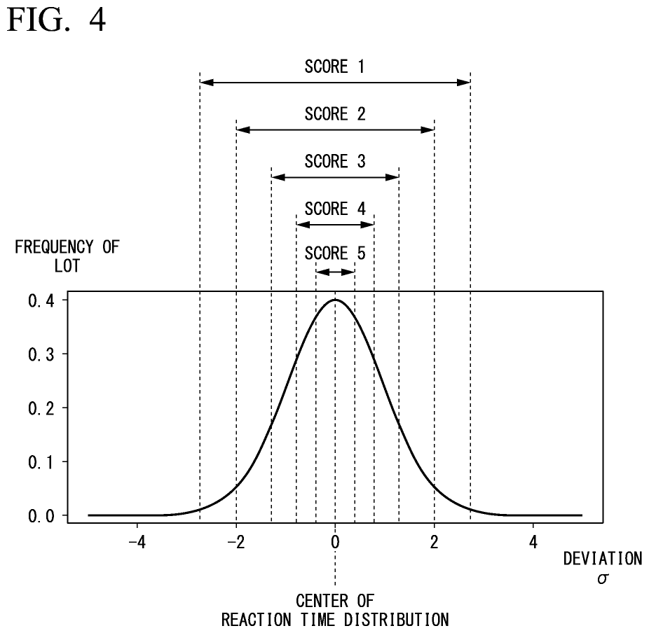

FIG. 4 is a diagram illustrating an example of the public value correlated with a reaction time for each product lot in the first embodiment. The horizontal axis represents a deviation (a distance from the center of a reaction time distribution) of an evaluation indicator value (for example, a reaction time) in each product lot. The vertical axis represents the frequency of the product lot. The public value generator 120 generates a public value for the reaction time which is an evaluation indicator in the current lot from the reaction time distribution (the deviation) in the past product lots. For example, as the reaction time becomes closer to the center of the distribution, the public value for the reaction time becomes higher. That is, the public value becomes closer to Score 5 (the highest score) as the reaction time becomes closer to a normal (usual) value, and the public value becomes closer to Score 1 (the lowest score) as the reaction time becomes farther from the normal value.

The public value generator 120 may generate the public value through comparison with a product lot determined to be more desirable (hereinafter referred to as a “reference lot”) in the past product lots instead of comparison with the distribution of the evaluation indicator values in the past product lots. For example, a Mahalanobis distance (MD) may be derived as the public value using a Mahalanobis Taguchi method (MT method) for a reference space which is constituted by the reference lot. The public value generator 120 may change a weight for the public value for each production factor depending on the weight for each production factor.

In the following description, the public value associated with the material evaluation indicator is referred to as a “material public value.” The public value associated with the machine evaluation indicator is referred to as a “machine public value.” The public value associated with the method evaluation indicator is referred to as a “method public value.” The public value associated with the man evaluation indicator is referred to as a “man public value.” The public value associated with the environment evaluation indicator is referred to as an “environment public value.”

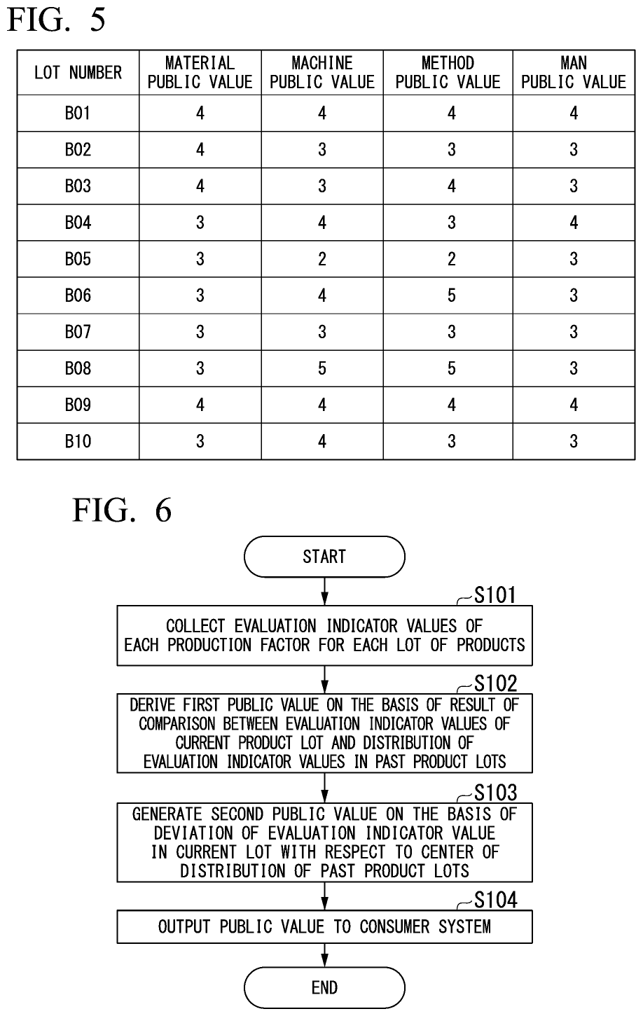

FIG. 5 is a diagram illustrating examples of the public values in the first embodiment. In FIG. 5, the material public value, the machine public value, the method public value, and the man public value are correlated with the corresponding product lot number. Each public value is generated, for example, in the form of a radar chart. The public value generator 120 transmits at least one of the material public value, the machine public value, the method public value, or the man public value and the lot number of the product 301 to the consumer system 200 in response to a consumer's request. The material public value, the machine public value, the method public value, the man public value, and the environment public value may be correlated with the corresponding product lot number. The public value generator 120 may transmit the environment public value to the consumer system 200.

An example of the operation of the evaluation system 1a will be described below.

FIG. 6 is a flowchart illustrating an example of the operation of the evaluation system 1a according to the first embodiment. The indicator value collector 10 collects the evaluation indicator values of the production factors from the production management system 4a for each product lot (Step S101). The evaluator 12a derives a result of comparison between the evaluation indicator values in the current product lot and the distribution of the evaluation indicator values in the past product lots as a first public value (a non-uniformity public value) of the evaluation indicator values. For example, as illustrated in FIG. 4, the evaluator 12a derives a result of comparison between the reaction time in the current product lot and the distribution of the values of the reaction time in the past product lots as the first public value of the reaction time (Step S102). The evaluator 12a generates a second public value (a deviation public value) of the evaluation indicator values on the basis of a deviation “σ” of the evaluation indicator values in the current product lot with respect to the center of the distribution of the past product lots. For example, as illustrated in FIG. 4, the evaluator 12a generates a score in the range of 1 to 5 as the second public value of the reaction time in the product lot under production on the basis of the deviation “σ” with respect to the center of the distribution of the values of the reaction time in the past product lots (Step S103). The evaluator 12a outputs the public value 101 including at least one of the first public value or the second public value to the consumer system 200 (Step S104).

As described above, the indicator value collector 10 collects the evaluation indicator values which are values of evaluation indicators which are predetermined in association with the production factors of the product 301 (for example, material, machine, method, man, and environment) for each lot of the product 301 under production. The public value generator 120 derives a distribution of the evaluation indicator values in the past product lots. The public value generator 120 generates the public value 101 on the basis of the deviations of the evaluation indicator values in the product lot under production with respect to the center of the distribution of the evaluation indicator values in the past product lots.

Accordingly, in the first embodiment, even when a producer presents the public value 101 to a consumer as the evaluation result of the production processes of the product 301, the public value 101 is not the corresponding evaluation indicator value (the process evaluation value) itself and thus it is possible to prevent another producer from imitating the production processes on the basis of the public value 101. The consumer can objectively evaluate the production processes of the product 301 on the basis of the public value 101.

### Second Embodiment

A second embodiment is different from the first embodiment in that a grouping part and a layering part are provided in the evaluator and the like. In the second embodiment, differences from the first embodiment will be mainly described.

In the following description, public values which have been grouped for each production factor are referred to as “grouped public values.” Layered grouped public values are referred to as “layered public values.”

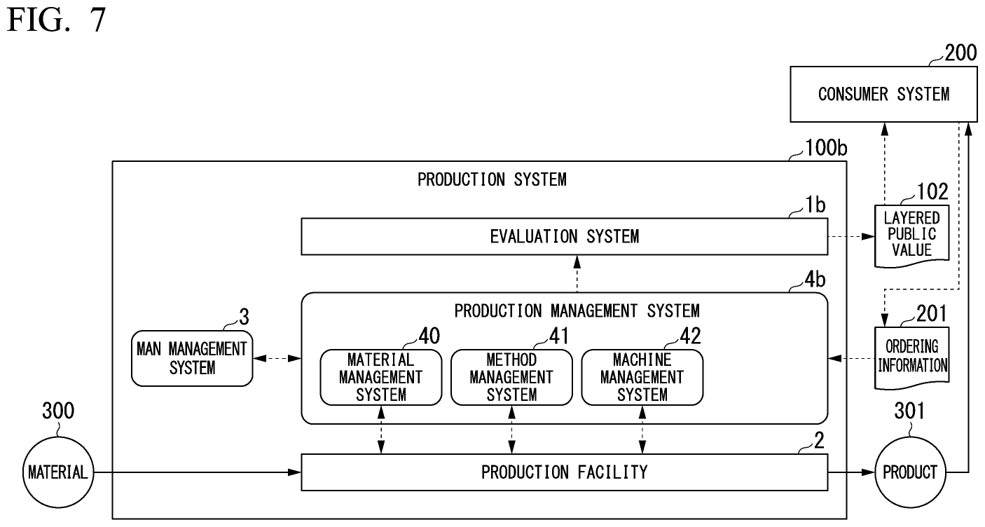

FIG. 7 is a diagram illustrating an example of a configuration of a production system 100b according to the second embodiment. The production system 100b includes an evaluation system 1b, a production facility 2, a man management system 3, and a production management system 4b. The production management system 4b includes a material management system 40, a method management system 41, and a machine management system 42.

The production system 100b produces a product 301 using a material 300 on the basis of ordering information 201 acquired from a consumer system 200. The production system 100b outputs a layered public value 102 and the product 301 to the consumer system 200.

An example of the configuration of the evaluation system 1b will be described below.

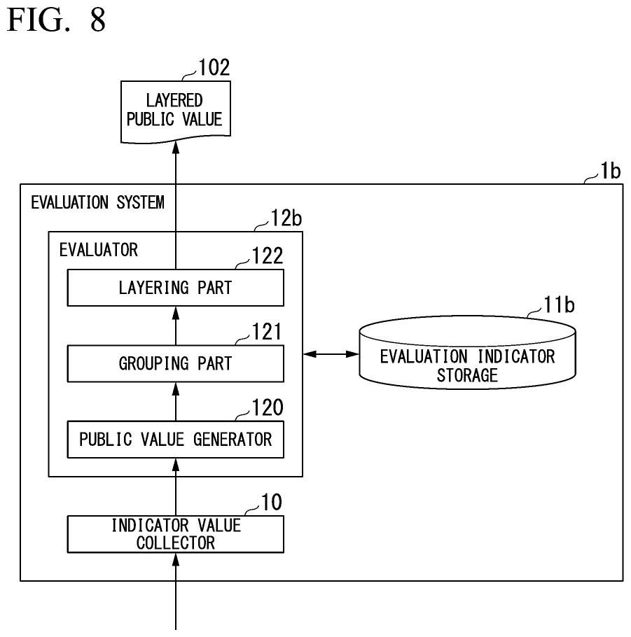

FIG. 8 is a diagram illustrating an example of the configuration of the evaluation system 1b according to the second embodiment. The evaluation system 1b includes an indicator value collector 10, an evaluation indicator storage 11b, and an evaluator 12b. The evaluator 12b includes a public value generator 120, a grouping part 121, and a layering part 122.

The indicator value collector 10 collects one or more evaluation indicator values from each production factor. In the first embodiment, one evaluation indicator is collected for each production factor, but two or more evaluation indicator values have to be often actually acquired for each production factor.

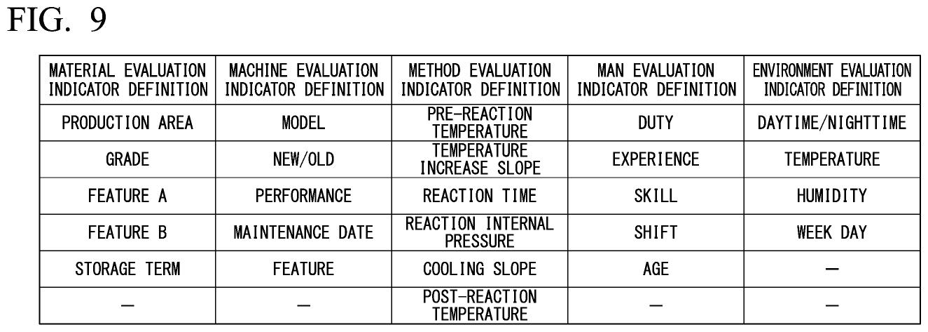

FIG. 9 illustrates an example of a list of the evaluation indicator values extracted for each production factor. In the following description, the evaluation indicator values for each production factor are collectively referred to as an “evaluation indicator definition.” In FIG. 9, a material evaluation indicator definition, a machine evaluation indicator definition, a method evaluation indicator definition, a man evaluation indicator definition, and an environment evaluation indicator definition are illustrated. For example, the material evaluation indicator definition includes a production area of a material, a grade of the material, feature A of the material, feature B of the material, and a storage term of the material. Details of the evaluation indicator definitions may be determined by a producer or may be determined in accordance with an instruction from a consumer. The evaluation indicator definitions (evaluation indicators selected for each production factor) may be stored in the evaluation indicator storage.

The public value generator 120 illustrated in FIG. 8 generates a public value for each evaluation indicator value collected by the indicator value collector 10 (in the same way as in the first embodiment). The grouping part 121 acquires a material public value, a machine public value, a method public value, and a man public value and a lot number of the product 301 from the public value generator 120. The grouping part 121 generates a grouped public value for each production factor by grouping the public values of the evaluation indicators on the basis of the aforementioned evaluation indicator definitions for each production factor.

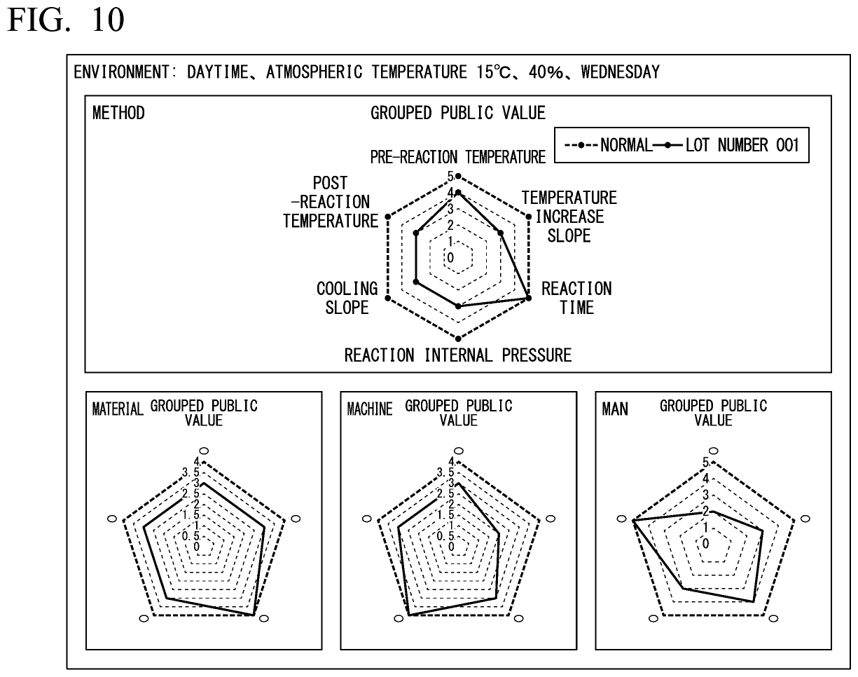

FIG. 10 is a diagram illustrating an example of the grouped public values in the second embodiment. The grouped public value for each production factor is generated, for example, in the form of a radar chart for a plurality of evaluation indicators. In FIG. 10, the grouped public value of the production factor “method” is generated in the form of a radar chart for an evaluation indicator “pre-reaction temperature,” an evaluation indicator “post-reaction temperature,” an evaluation indicator “cooling slope,” an evaluation indicator “reaction internal pressure,” an evaluation indicator “reaction time,” and an evaluation indicator “temperature increase slope.” In this example, the public value in the vertical axis of the radar chart becomes closer to Score 5 (the highest score) as it becomes closer to a normal (usual) value, and becomes closer to Score 1 (the lowest score) as it becomes farther from the normal value, but another expression may be used for the public values.

The grouped public value for each production factor is arranged for evaluation indicators which are predetermined as operation conditions. In FIG. 10, the grouped public value of the production factor “method,” the grouped public value of the production factor “material,” the grouped public value of the production factor “machine,” and the grouped public value of the production factor “man” are arranged for environment evaluation indicators “daytime, temperature, humidity, and week day” which are the operation conditions. The grouping part 121 outputs the grouped public values and the product lot number thereof to the layering part 122.

The grouping unit 121 may transmit the grouped public values and the product lot number to the consumer system 200. The grouped public values illustrated in HG. 10 may be displayed on a display device (not illustrated) of the consumer system 200.

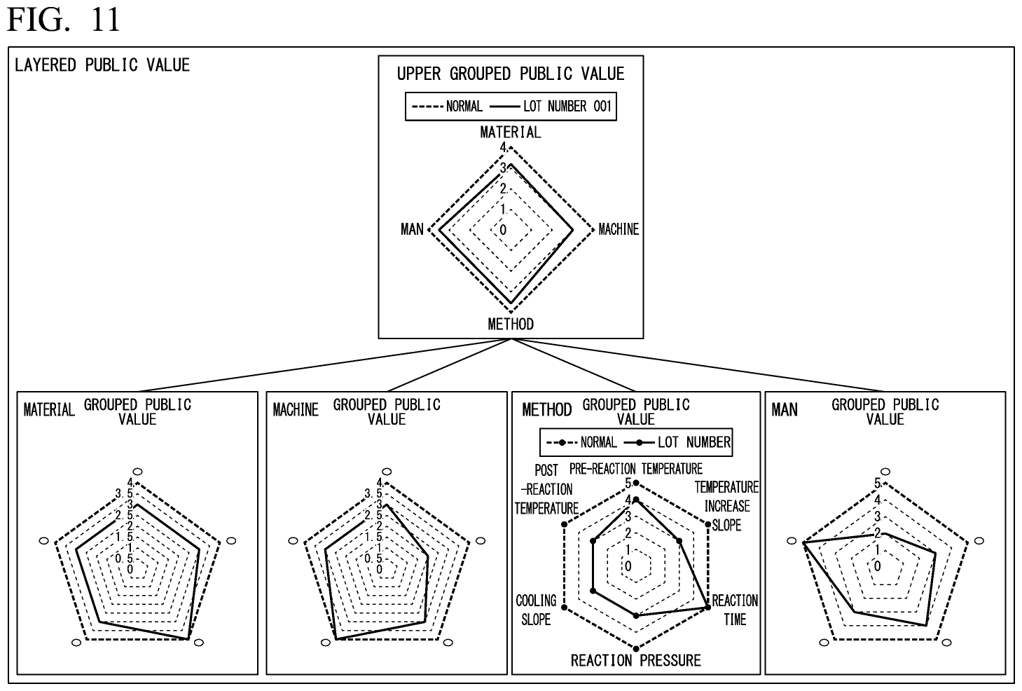

FIG. 11 is a diagram illustrating an example of the layered public values in the second embodiment. The layering part 122 acquires the grouped public values from the grouping part 121 for each product lot. In FIG. 11, the layering part 122 acquires the grouped public value of the production factor “material,” the grouped public value of the production factor “machine,” the grouped public value of the production factor “method,” and the grouped public value of the production factor “man” from the grouping part 121 for each product lot.

The layering part 122 additionally groups the grouped public values for a plurality of production factors. In the following description, a grouping result of grouping the grouped public values of the plurality of production factors is referred to as an “upper grouped public value.” In FIG. 11, the upper grouped public value is generated in the form of a radar chart for the grouped public value of the production factor “material,” the grouped public value of the production factor “machine,” the grouped public value of the production factor “method,” and the grouped public value of the production factor “man.” The layering part 122 generates the layered public value 102 by setting the upper grouped public value as an upper layer and setting the grouped public values for the production factors as a lower layer.

The layered public value 102 is generated, for example, in the form of a layered radar chart for a plurality of production factors. In FIG. 11, the layered public value 102 is generated, for example, in the form of a layered radar chart for the production factor “material,” the production factor “machine,” the production factor “method,” and the production factor “man.” For example, the value of the vertical axis (0 to 4) in the radar chart may be determined on the basis of balance between the public values of the production factors or the like. The layering part 122 transmits the layered public value 102 and the product lot number to the consumer system 200. The layered public value 102 is displayed on a display device (not illustrated) of the consumer system 200.

The evaluator 12c may receive, for example, a signal of a click operation as a signal of an operation (a drill-down operation) for drilling down the evaluation indicator values to inspect items of the evaluation indicator values in more detail. For example, when an area indicated by “material” in the upper grouped public value is clicked in a state in which the grouped public values illustrated in FIG. 11 are displayed on a display device (not illustrated) and the radar chart of the grouped public value of the production factor “material” is not displayed, the evaluator 12c may cause the radar chart of the grouped public value of the production factor “material” to be displayed.

As described above, the grouping part 121 generates the grouped public value for each production factor by grouping the public values of a plurality of evaluation indicators for each production factor. The layering part 122 generates the layered public value 102 by setting the upper grouped public value as an upper layer and setting the grouped public value for each production factor as a lower layer.

Accordingly, in the second embodiment, even when a producer presents the grouped public value or the layered public value 102 to a consumer as the evaluation result of the production factors of a product, the grouped public value or the layered public value 102 is not the corresponding evaluation indicator value itself and thus it is possible to prevent another producer from imitating the production processes on the basis of the grouped public value or the layered public value 102. The layering part 122 can understandably display the evaluation indicators serving as an obstructive factor causing non-uniformity in product quality on a display device (not illustrated) using a radar chart. The layering part 122 can understandably display the evaluation indicators serving as an obstructive factor causing non-uniformity in product quality on a display device (not illustrated) through a drill-down process on the layered public value.

### Third Embodiment

A third embodiment is different from the second embodiment in that a production management system includes a quality management system and an evaluation system includes a quality value generator. In the third embodiment, differences from the second embodiment will be mainly described.

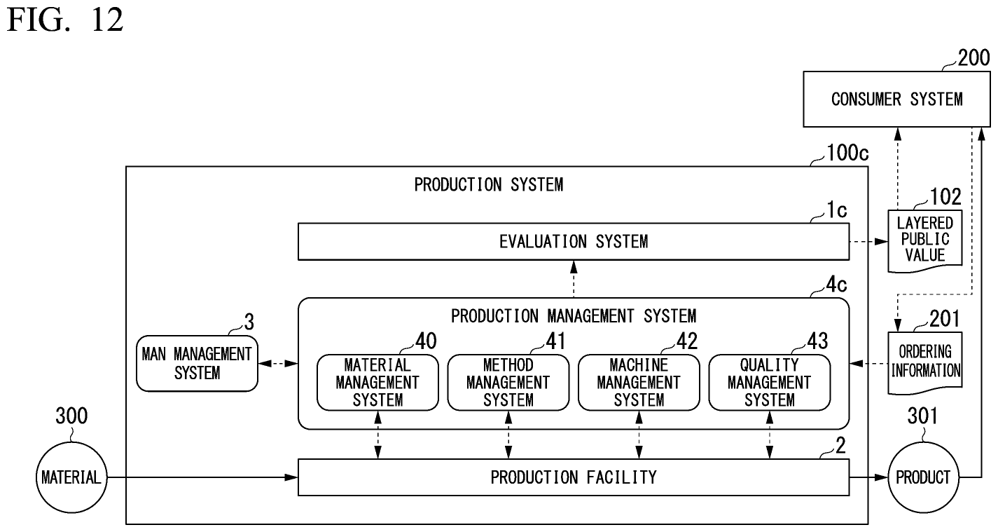

FIG. 12 is a diagram illustrating an example of a configuration of a production system 100c according to the third embodiment. The production system 100c includes an evaluation system 1c, a production facility 2, a man management system 3, and a production management system 4c. The production management system 4c includes a material management system 40, a method management system 41, a machine management system 42, and a quality management system 43. The quality management system 43 generates an output evaluation value which is predetermined in association with quality of a product (hereinafter referred to as a “quality evaluation indicator value”).

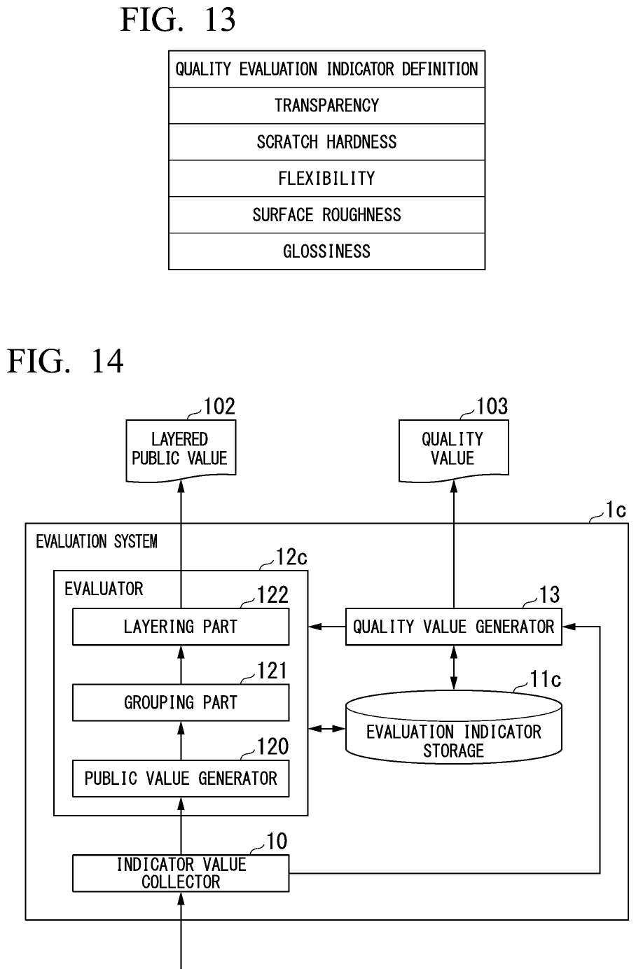

FIG. 13 is a diagram illustrating an example of a quality evaluation indicator definition in which a plurality of predetermined output evaluation values are defined as constituent items in the third embodiment. In FIG. 13, the quality evaluation indicator definition includes, for example, transparency, scratch hardness, flexibility, surface roughness, and glossiness. The production management system 4c transmits a quality evaluation indicator value to the evaluation system 1c. The quality evaluation indicator definition may be stored in an evaluation indicator storage which will be described later.

An example of the configuration of the evaluation system 1c will be described below.

FIG. 14 is a diagram illustrating an example of a configuration of the evaluation system 1c in the third embodiment. The evaluation system 1c includes an indicator value collector 10, an evaluation indicator storage 11c, an evaluator 12c, and a quality value generator 13.

The indicator value collector 10 collects a material evaluation indicator value, a machine evaluation indicator value, a method evaluation indicator value, a man evaluation indicator value, an environment evaluation indicator value which are process evaluation values and a quality evaluation indicator value which is an output evaluation value from the production management system 4c for each product lot. The indicator value collector 10 acquires a product lot number of a product 301 from the production management system 4c. The indicator value collector 10 transmits the material evaluation indicator value, the machine evaluation indicator value, the method evaluation indicator value, the man evaluation indicator value, the environment evaluation indicator value, and the product lot number of the product 301 to the evaluator 12c. The indicator value collector 10 transmits the quality evaluation indicator values of the quality evaluation indicators and the product lot number of the product 301 to the quality value generator 13.

The quality value generator 13 acquires the quality evaluation indicator value and the product lot number of the product 301 from the indicator value collector 10. The quality value generator 13 acquires the quality evaluation indicator definition from the evaluation indicator storage 11c. The quality value generator 13 generates an indicator value of a deviation in a distribution of evaluation indicators which are predetermined in association with the quality of the products (hereinafter referred to as a “quality value”) on the basis of the quality evaluation indicator values of the quality evaluation indicators.

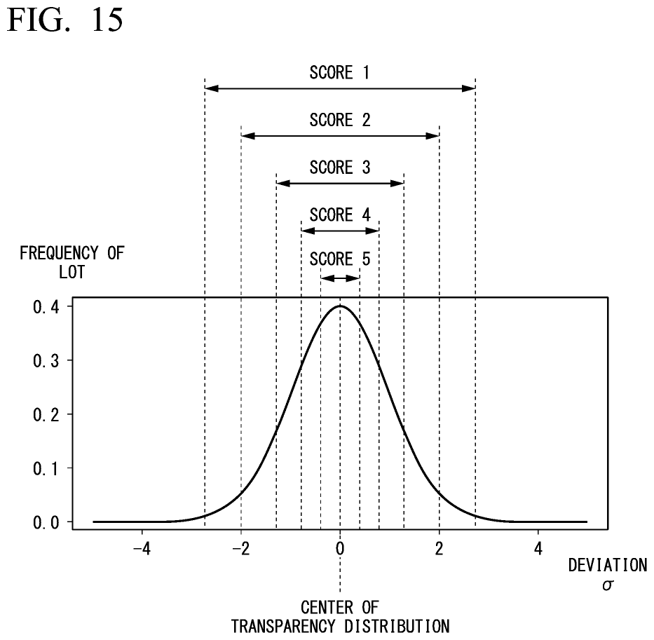

FIG. 15 is a diagram illustrating an example of the quality values correlated with transparency for each of a plurality of product lots in the third embodiment. The horizontal axis represents a transparency distribution in a plurality of product lots. The vertical axis represents a frequency of a product lot. The public value generator 120 derives a quality value for transparency which is an evaluation indicator for each product lot. The public value for transparency becomes greater as the transparency becomes closer to the center of the transparency distribution. That is, the public value becomes closer to Score 5 (the highest score) as the transparency becomes closer to a normal (usual) value. The public value for transparency becomes closer to Score 1 (the lowest score) as the transparency becomes farther from a normal value.

The quality value generator 13 may generate the quality value through comparison with a product lot determined to be more desirable (hereinafter referred to as a “reference lot”) in the past product lots instead of comparison with the quality value distribution in the past product lots. For example, the quality value generator 13 may derive a Mahalanobis distance as the quality value using a Mahalanobis Taguchi method for a reference space which is constituted by the reference lot. The quality value generator 13 may change a weight of the quality value for each evaluation indicator depending on the weight of each evaluation indicator.

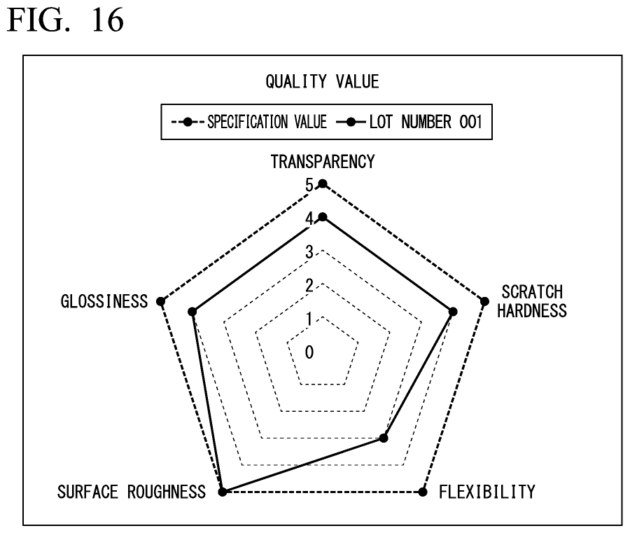

FIG. 16 is a diagram illustrating an example of the quality value in the third embodiment. The quality value generator 13 generates the quality value by grouping (clustering) the quality evaluation indicator values of a plurality of quality evaluation indicators. In FIG. 16, the quality value generator 13 generates, for example, the quality values including a quality evaluation indicator value for transparency, a quality evaluation indicator value for scratch hardness, a quality evaluation indicator value for flexibility, a quality evaluation indicator value for surface roughness, and a quality evaluation indicator value for glossiness for each product lot. For example, the quality value generator 13 generates the quality values in the form of a radar chart. In this example, the quality value on the vertical axis of the radar chart becomes closer to Score 5 (the highest score) as it becomes closer to a normal (usual) value, and becomes closer to Score 1 (the lowest score) as it becomes farther from a normal value, but the quality value may be expressed in another form. The quality value generator 13 transmits the quality value 103 to the consumer system 200.

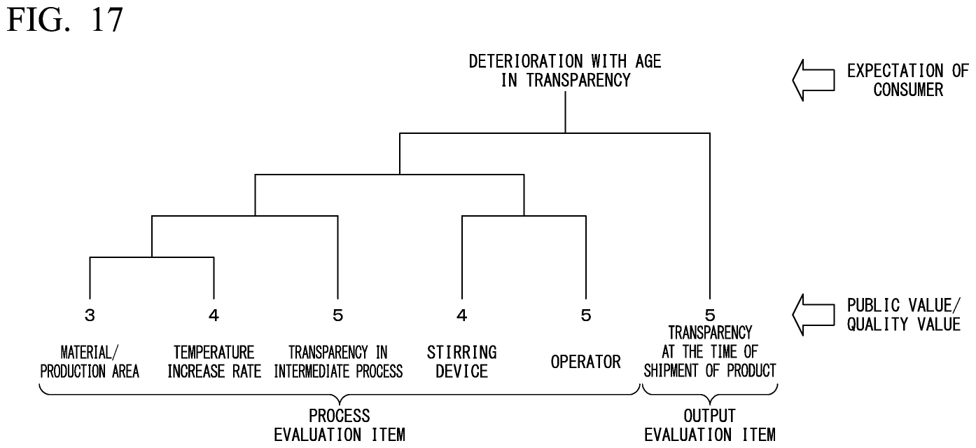

FIG. 17 is a diagram illustrating an example of a tree diagram of public values of evaluation indicator values and quality values in the third embodiment. In order to verify expectations in which it is intended to curb deterioration with age in transparency and which cannot be expressed by the output evaluation values, the quality value generator 13 may transmit the public values of the process evaluation items and the quality values of the output evaluation items to the consumer system 200 in correlation with the product lot number. In FIG. 17, for example, the public values of the material and the production area are 3, which indicates to be different from normal values. In order to cope with this, processing is performed at a temperature increase rate (public value=4) which is slightly different from a normal value. As a result, transparency in an intermediate process has a usual value (public value=5). A stirring device exhibits a distribution (public value=4, for example, a stirring rate deviates slightly) which is slightly different from a normal value, and the same transparency distribution (quality value=5) as usual is obtained as a product by allowing the same worker as usual to perform the work (public value=5). A consumer can have reliability in the same product lot by providing these numerical values to the consumer.

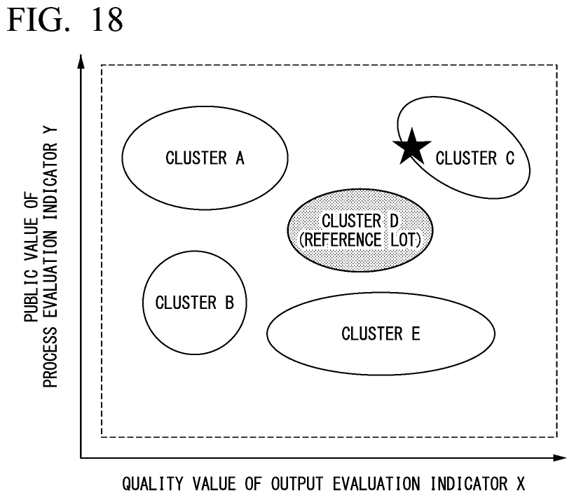

FIG. 18 is a diagram illustrating an example of a scatter diagram of a public value which is a process evaluation indicator and a quality value which is an output evaluation indicator in the third embodiment. The horizontal axis represents the quality values of the output evaluation indicators correlated with a plurality of product lot numbers. The vertical axis represents the public values of the process evaluation indicators correlated with a plurality of lot numbers. The quality value generator 13 may transmit a scatter diagram of the quality values and the public values to the consumer system 200. In FIG. 18, for example, it can be seen that a plurality of past product lots are classified and distributed into five clusters A to E. A dotted rectangular frame indicates an allowable range, and all product lots are in a common range in this example. For example, at what position a current lot under production (or a production lot which is currently picked) is located may be represented (a star in the drawing). When a reference lot is provided, the reference lot may be clearly shown. As described above, the quality value generator has a function of providing the public values of the process evaluation indicators and the quality values of the output evaluation indicators in the product lot to a consumer in correlation with each other.

The quality management system 43 illustrated in FIG. 12 may determine what group the lot of the product 301 under production belongs to using the scatter diagram while producing the product 301. In this case, the quality management system 43 may set, for example, a public value Z of a process evaluation indicator as the horizontal axis of FIG. 18. When a status of the current lot under production is located at the position of star, subsequent processes may be adjusted such that the current lot becomes closer to Cluster D which is a reference lot.

The quality value generator 13 transmits the quality value 103 and the product lot number to the consumer system 200. The quality value generator 13 outputs the product lot number to the evaluator 12c. The product lot number is correlated with the layered public value 102 by the evaluator 12c.

As described above, the quality value generator 13 generates the quality value 103 on the basis of the quality evaluation indicator values. The quality value generator 13 transmits the quality value 103 and the product lot number to the consumer system 200. The evaluator 12c correlates at least one of the public value 101, the grouped public value, or the layered public value 102 with the quality value 103. The evaluator 12c transmits at least one of the public value, the grouped public value, or the layered public value 102, and the product lot number to the consumer system 200.

Accordingly, in the third embodiment, even when the layered public value 102 which is the evaluation result of non-uniformity in the production factors of the product 301 is presented from a producer to a consumer, the layered public value 102 is not an evaluation indicator value (a value of a process management point) itself and thus it is possible to prevent another producer from imitating the production processes on the basis of the layered public value 102. Since correlation information between the layered public value 102 and the quality value which is an output evaluation indicator is known to a consumer, the consumer can receive the product 301 in relief.

While embodiments of the invention have been described above with reference to the drawings, a specific configuration of the invention is not limited to the embodiments and includes a design or the like without departing from the gist of the invention.

Some or all of the functional units of the aforementioned production system and the consumer system are realized in software by causing a processor such as a central processing unit (CPU) to execute a program stored in a storage unit. That is, some or all functions of the functional units of the evaluation system are realized in combination of software and hardware resources. The evaluation system of the production system may be realized by cloud computing.

The aforementioned program may be stored in a computer-readable recording medium. The computer-readable recording medium is a non-transitory recording medium of a storage device such as a portable medium such as a flexible disc, a magneto-optical disc, a read only memory (ROM), or a compact disc-read only memory (CD-ROM) or a hard disk which is incorporated into a computer system. The program may be received via a communication line.

Some or all of the functional units of the evaluation system may be realized in hardware. For example, such functional units may be realized by an electronic circuit or circuitry using a large-scale integration circuit (LSI), an application-specific integrated circuit (ASIC), a programmable logic device (PLD), a field programmable gate array (FPGA), or the like.

(Supplementary Note)

An evaluation system (1a) according to an aspect of the invention may include an indicator value collector (10) configured to collect evaluation indicator values which are values of evaluation indicators predetermined in association with production factors of products for each lot of the products and an evaluator (12a) configured to derive a distribution of the evaluation indicator values for a plurality of lots and to generate public values (101) which are values for making the evaluation indicators public for each of the lots based on a deviation of the evaluation indicator values in the distribution.

In the evaluation system (1b) according to an aspect of the invention, the evaluator (12b) may generate a grouped public value which is a grouped value of the public values for each production factor by grouping the public values of the plurality of evaluation indicators for each production factor.

In the evaluation system (1c) according to an aspect of the invention, the evaluator (12c) may generate layered public values (102) which are layered values of the grouped public values by setting upper grouped public values which are results of additionally grouping the grouped public values of the plurality of production factors as an upper layer and setting the grouped public values for each production factor as a lower layer.

In the evaluation system according to an aspect of the invention, the evaluator may generate at least one of the public values, the grouped public values, or the layered public values in the form of a radar chart.

The evaluation system according to an aspect of the invention may further include a quality value generator (13) configured to generate a quality value (103) which is an indicator value of a deviation of quality of the products in a distribution of evaluation indicators which are predetermined in association with the quality of the products based on quality evaluation indicator values which are values of the evaluation indicators which are predetermined in association with the quality of the products, and the evaluator may correlate at least one of the public values, the grouped public values, or the layered public values with the quality value.

In the evaluation system according to an aspect of the invention, the indicator value collector may collect the evaluation indicator values from a production management system controlling a production facility which produces the product, and the evaluator may transmit the public values to a consumer system managed by a consumer of the product.

In the evaluation system according to an aspect of the invention, the quality value generator may transmit a scatter diagram of the quality value and the public values to the consumer system.

An evaluation method according to an aspect of the invention is an evaluation method that is performed by an evaluation system and includes an indicator value collecting step of collecting evaluation indicator values which are values of evaluation indicators predetermined in association with production factors of products for each lot of the products and an evaluation step of deriving a distribution of the evaluation indicator values for a plurality of lots and generating public values (101) which are values for making the evaluation indicators public for each of the lots based on a deviation of the evaluation indicator values in the distribution.

The evaluation method according to an aspect of the invention may further include generating a grouped public value which is a grouped value of the public values for each production factor by grouping the public values of the plurality of evaluation indicators for each production factor.

The evaluation method according to an aspect of the invention may further include generating layered public values which are layered values of the grouped public values by setting upper grouped public values which are results of additionally grouping the grouped public values of the plurality of production factors as an upper layer and setting the grouped public values for each production factor as a lower layer.

The evaluation method according to an aspect of the invention may further include generating at least one of the public values, the grouped public values, or the layered public values in the form of a radar chart.

The evaluation method according to an aspect of the invention may further include generating a quality value which is an indicator value of a deviation of quality of the products in a distribution of evaluation indicators which are predetermined in association with the quality of the products based on quality evaluation indicator values which are values of the evaluation indicators which are predetermined in association with the quality of the products, and correlating at least one of the public values, the grouped public values, or the layered public values with the quality value.

The evaluation method according to an aspect of the invention may further include collecting the evaluation indicator values from a production management system controlling a production facility which produces the product, and transmitting the public values to a consumer system managed by a consumer of the product.

The evaluation method according to an aspect of the invention may further include transmitting a scatter diagram of the quality value and the public values to the consumer system.

A non-transitory computer readable storage medium according to an aspect of the invention is a non-transitory computer readable storage medium storing a program executed by a computer of an evaluation system, and the program may instruct the computer to collect evaluation indicator values which are values of evaluation indicators predetermined in association with production factors of products for each lot of the products, derive a distribution of the evaluation indicator values for a plurality of lots, and generate public values which are values for making the evaluation indicators public for each of the lots based on a deviation of the evaluation indicator values in the distribution.

In the non-transitory computer readable storage medium according to an aspect of the invention, the program may further instruct the computer to generate a grouped public value which is a grouped value of the public values for each production factor by grouping the public values of the plurality of evaluation indicators for each production factor.

In the non-transitory computer readable storage medium according to an aspect of the invention, the program may further instruct the computer to generate layered public values which are layered values of the grouped public values by setting upper grouped public values which are results of additionally grouping the grouped public values of the plurality of production factors as an upper layer and setting the grouped public values for each production factor as a lower layer.

In the non-transitory computer readable storage medium according to an aspect of the invention, the program may further instruct the computer to generate at least one of the public values, the grouped public values, or the layered public values in the form of a radar chart.

In the non-transitory computer readable storage medium according to an aspect of the invention, the program may further instruct the computer to generate a quality value which is an indicator value of a deviation of quality of the products in a distribution of evaluation indicators which are predetermined in association with the quality of the products based on quality evaluation indicator values which are values of the evaluation indicators which are predetermined in association with the quality of the products, and correlate at least one of the public values, the grouped public values, or the layered public values with the quality value.

In the non-transitory computer readable storage medium according to an aspect of the invention, the program may further instruct the computer to collect the evaluation indicator values from a production management system controlling a production facility which produces the product, and transmit the public values to a consumer system managed by a consumer of the product.

According to the invention, it is possible to secure reliability of products by consumers (reliability indicating that there is no change in product quality from that in the past) and to prevent leakage of production know-how of the products or the like to a third party.

As used herein, the following directional terms “front, back, above, downward, right, left, vertical, horizontal, below, transverse, row and column” as well as any other similar directional terms refer to those instructions of a device equipped with the present invention. Accordingly, these terms, as utilized to describe the present invention should be interpreted relative to a device equipped with the present invention.

The term “configured” is used to describe a component, unit or part of a device includes hardware and/or software that is constructed and/or programmed to carry out the desired function.

Moreover, terms that are expressed as “means-plus function” in the claims should include any structure that can be utilized to carry out the function of that part of the present invention.

The term “unit” is used to describe a component, unit or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. An evaluation system comprising:
an indicator value collector configured to collect evaluation indicator values which are values of evaluation indicators predetermined in association with production factors of products for each lot of the products; and
an evaluator configured to derive a distribution of the evaluation indicator values for a plurality of lots and to generate public values which are values for making the evaluation indicators public for each of the lots based on a deviation of the evaluation indicator values in the distribution.

2. The evaluation system according to claim 1,
wherein the evaluator is configured to generate a grouped public value which is a grouped value of the public values for each production factor by grouping the public values of the plurality of evaluation indicators for each production factor.

3. The evaluation system according to claim 2,
wherein the evaluator is configured to generate layered public values which are layered values of the grouped public values by setting upper grouped public values which are results of additionally grouping the grouped public values of the plurality of production factors as an upper layer and setting the grouped public values for each production factor as a lower layer.

4. The evaluation system according to claim 3,
wherein the evaluator is configured to generate at least one of the public values, the grouped public values, or the layered public values in the form of a radar chart.

5. The evaluation system according to claim 3, further comprising:
a quality value generator configured to generate a quality value which is an indicator value of a deviation of quality of the products in a distribution of evaluation indicators which are predetermined in association with the quality of the products based on quality evaluation indicator values which are values of the evaluation indicators which are predetermined in association with the quality of the products,
wherein the evaluator is configured to correlate at least one of the public values, the grouped public values, or the layered public values with the quality value.

6. The evaluation system according to claim 5,
wherein the indicator value collector is configured to collect the evaluation indicator values from a production management system controlling a production facility which produces the product, and
wherein the evaluator is configured to transmit the public values to a consumer system managed by a consumer of the product.

7. The evaluation system according to claim 6,
wherein the quality value generator is configured to transmit a scatter diagram of the quality value and the public values to the consumer system.

8. An evaluation method that is performed by an evaluation system, comprising:
collecting evaluation indicator values which are values of evaluation indicators predetermined in association with production factors of products for each lot of the products;
deriving a distribution of the evaluation indicator values for a plurality of lots; and
generating public values which are values for making the evaluation indicators public for each of the lots based on a deviation of the evaluation indicator values in the distribution.

9. The evaluation method according to claim 8, further comprising:
generating a grouped public value which is a grouped value of the public values for each production factor by grouping the public values of the plurality of evaluation indicators for each production factor.

10. The evaluation method according to claim 9, further comprising:
generating layered public values which are layered values of the grouped public values by setting upper grouped public values which are results of additionally grouping the grouped public values of the plurality of production factors as an upper layer and setting the grouped public values for each production factor as a lower layer.

11. The evaluation method according to claim 10, further comprising:
generating at least one of the public values, the grouped public values, or the layered public values in the form of a radar chart.

12. The evaluation method according to claim 10, further comprising:
generating a quality value which is an indicator value of a deviation of quality of the products in a distribution of evaluation indicators which are predetermined in association with the quality of the products based on quality evaluation indicator values which are values of the evaluation indicators which are predetermined in association with the quality of the products; and
correlating at least one of the public values, the grouped public values, or the layered public values with the quality value.

13. The evaluation method according to claim 12, further comprising:
collecting the evaluation indicator values from a production management system controlling a production facility which produces the product; and
transmitting the public values to a consumer system managed by a consumer of the product.

14. The evaluation method according to claim 13, further comprising:
transmitting a scatter diagram of the quality value and the public values to the consumer system.

15. A non-transitory computer readable storage medium storing a program executed by a computer of an evaluation system, the program instructing the computer to:
collect evaluation indicator values which are values of evaluation indicators predetermined in association with production factors of products for each lot of the products;
derive a distribution of the evaluation indicator values for a plurality of lots; and
generate public values which are values for making the evaluation indicators public for each of the lots based on a deviation of the evaluation indicator values in the distribution.

16. The non-transitory computer readable storage medium according to claim 15, wherein the program further instructs the computer to:
generate a grouped public value which is a grouped value of the public values for each production factor by grouping the public values of the plurality of evaluation indicators for each production factor.

17. The non-transitory computer readable storage medium according to claim 16, wherein the program further instructs the computer to:
generate layered public values which are layered values of the grouped public values by setting upper grouped public values which are results of additionally grouping the grouped public values of the plurality of production factors as an upper layer and setting the grouped public values for each production factor as a lower layer.

18. The non-transitory computer readable storage medium according to claim 17, wherein the program further instructs the computer to:
generate at least one of the public values, the grouped public values, or the layered public values in the form of a radar chart.

19. The non-transitory computer readable storage medium according to claim 17, wherein the program further instructs the computer to:
generate a quality value which is an indicator value of a deviation of quality of the products in a distribution of evaluation indicators which are predetermined in association with the quality of the products based on quality evaluation indicator values which are values of the evaluation indicators which are predetermined in association with the quality of the products; and
correlate at least one of the public values, the grouped public values, or the layered public values with the quality value.

20. The non-transitory computer readable storage medium according to claim 19, wherein the program further instructs the computer to:
collect the evaluation indicator values from a production management system controlling a production facility which produces the product; and
transmit the public values to a consumer system managed by a consumer of the product.
